(19) United States
(12) Patent Application Publication
(10) Pub. No.: US 2011/0209042 A1
(43) Pub. Date: Aug. 25, 2011

(54) Information Technology Standard Inventory Utility

(75) Inventor: Mark A. Porter, Nederland, CO (US)

(73) Assignee: INTERNATIONAL BUSINESS MACHINES CORPORATION, Armonk, NY (US)

(21) Appl. No.: 12/712,707

(22) Filed: Feb. 25, 2010

(51) Int. Cl. G06F 17/00; G06Q 10/00; G06F 3/048

(52) U.S. Cl. 715/212; 715/227; 705/28; 715/764

(57) ABSTRACT

A method and system for automating the processes of organizing and analyzing client inventory data. Inventory data in a first worksheet format and user-defined mappings between columns in the first worksheet format and columns in a standard format worksheet are received from a client. The inventory data is organized by copying inventory data columns to corresponding mapped columns in the standard format worksheet. A first set of independent subroutines analyzes the organized data by standardizing text in the data and populating columns in the standard format worksheet with data derived from the inventory data. A second set of independent subroutines is applied to the analyzed inventory data to sort inventory assets listed in the standard format worksheet by asset type and determine a total count of types of assets. The sorted asset type data is displayed to a user.

### BACKGROUND

1. Field:

The disclosure relates generally to an improved data processing system, and more specifically to a system and method for automating the processes of organizing and analyzing client inventory data into a standard format to enable a user to quickly understand the scope of a client's inventory.

2. Description of the Related Art

The analysis of client inventory data is an important part of the information technology (IT) solution development process for determining which vendor service offerings best fit the client's IT needs. A request for proposal (RFP) is a document that invites a vendor to submit a bid to the client for hardware, software, and/or services. Typical RFP bid submission processes require that the client provide a detailed listing to the vendor that lists the client's existing IT inventory. Each line item in the inventory data contains information about a particular IT asset of the client. Analyzing client inventory data enables vendor personnel to understand the client's IT assets and scope of services being requested by the client, and to recommend service offerings for the client. Often times, client inventory data submitted to the vendor contains thousands of line item entries organized into scores of columns within a spreadsheet program, such as Microsoft Excel®. Microsoft Excel is a trademarked product of Microsoft Corporation. Each column in the worksheet specifies a particular attribute of the line item asset. Example worksheet columns may include the manufacturer of the asset, the model, part number, processor quantity, or other asset features.

### SUMMARY

The illustrative embodiments comprise a computer implemented method, apparatus, and computer program product for automating the processes of organizing and analyzing client inventory data into a standard format to enable a user to quickly understand the scope of a client's inventory. A first set of inventory data in a first worksheet format is received from a client. Responsive to receiving user-defined mappings between columns in the first worksheet format and columns in a standard format worksheet, the first set of inventory data is organized by copying each column of the first set of inventory data to its corresponding mapped column in the standard format worksheet to form organized inventory data. A first set of independent subroutines is applied to the organized inventory data to analyze the data by standardizing text in the organized inventory data and populating one or more columns in the standard format worksheet with data derived from the first set of inventory data to form analyzed inventory data. A second set of independent subroutines is applied to the analyzed inventory data to sort inventory assets listed in the standard format worksheet by asset type and determine a total count of assets in each asset type to form sorted asset type data. The sorted asset type data is displayed to a user.

### BRIEF DESCRIPTION OF THE SEVERAL VIEWS OF THE DRAWINGS

FIG. 1 is a block diagram of a data processing system in which the illustrative embodiments may be implemented;

FIG. 2 is a block diagram of a spreadsheet application for organizing and analyzing client inventory data in accordance with the illustrative embodiments;

FIG. 3 is an integrated view of components comprising the initial client inventory data load and independent macros in accordance with the illustrative embodiments;

FIGS. 4A and 4B illustrate an example of client inventory data as initially received by a vendor and after the data is organized and analyzed by the inventory utility in accordance with the illustrative embodiments;

FIG. 5 is an exemplary pop up window through which the user may input specifics related to workbooks and worksheets and set the column mapping structure between selected client provided inventory data and a standard format worksheet in accordance with the illustrative embodiments;

FIG. 6 is an exemplary user interface through which inventory data processing and analyzing functions may be initiated in accordance with the illustrative embodiments;

FIG. 7 is a pop up window illustrating exemplary bucket sort and scatter tally results displayed to the user in accordance with the illustrative embodiments;

FIG. 8 is an exemplary reusable intellectual capital worksheet report in accordance with the illustrative embodiments;

FIG. 9 is a flowchart of a process for organizing and analyzing client inventory data in an automated manner in accordance with the illustrative embodiments;

FIG. 10 is a flowchart illustrating mapping and inventory load macro code processing in accordance with the illustrative embodiments;

FIG. 11 is a flowchart of a process for further analyzing client inventory data in an automated manner using independent macros in accordance with the illustrative embodiments; and

FIG. 12 is a flowchart illustrating exemplary macro code processing in accordance with the illustrative embodiments.

### DETAILED DESCRIPTION

As will be appreciated by one skilled in the art, aspects of the disclosure may be embodied as a system, method or computer program product. Accordingly, aspects of the disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the disclosure may take the form of a computer program product embodied in any tangible medium of expression having computer usable program code embodied in the medium.

Any combination of one or more computer usable or computer readable medium(s) may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CDROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to wireless, wireline, optical fiber cable, RF, etc.

Computer program code for carrying out operations of the aspects of the disclosure may be written in any combination of one or more programming languages, including an object oriented programming language such as Java, Smalltalk, C++, Voice eXtensible Markup Language (VXML) or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The aspects of the disclosure are described below with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions.

These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

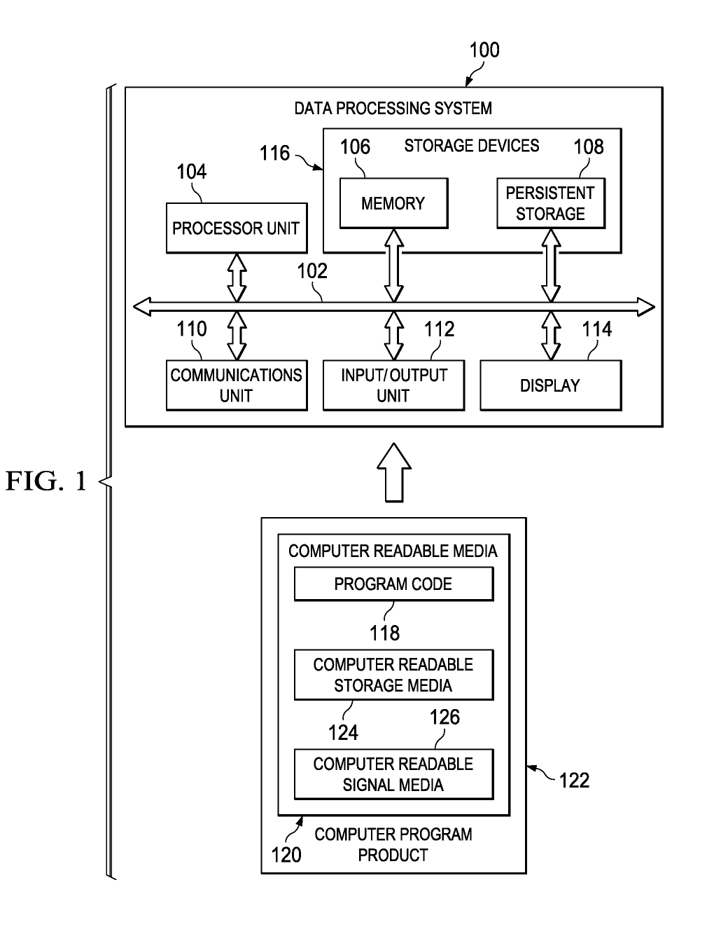

Turning now to FIG. 1, a diagram of a data processing system is depicted in accordance with an illustrative embodiment. In this illustrative example, data processing system 100 includes communications fabric 102, which provides communications between processor unit 104, memory 106, persistent storage 108, communications unit 110, input/output (I/O) unit 112, and display 114.

Processor unit 104 serves to execute instructions for software that may be loaded into memory 106. Processor unit 104 may be a set of one or more processors or may be a multi-processor core, depending on the particular implementation. Further, processor unit 104 may be implemented using one or more heterogeneous processor systems, in which a main processor is present with secondary processors on a single chip. As another illustrative example, processor unit 104 may be a symmetric multi-processor system containing multiple processors of the same type.

Memory 106 and persistent storage 108 are examples of storage devices 116. A storage device is any piece of hardware that is capable of storing information, such as, for example, without limitation, data, program code in functional form, and/or other suitable information either on a temporary basis and/or a permanent basis. Memory 106, in these examples, may be, for example, a random access memory, or any other suitable volatile or non-volatile storage device. Persistent storage 108 may take various forms, depending on the particular implementation. For example, persistent storage 108 may contain one or more components or devices. For example, persistent storage 108 may be a hard drive, a flash memory, a rewritable optical disk, a rewritable magnetic tape, or some combination of the above. The media used by persistent storage 108 may be removable. For example, a removable hard drive may be used for persistent storage 108.

Communications unit 110, in these examples, provides for communication with other data processing systems or devices. In these examples, communications unit 110 is a network interface card. Communications unit 110 may provide communications through the use of either or both physical and wireless communications links.

Input/output unit 112 allows for the input and output of data with other devices that may be connected to data processing system 100. For example, input/output unit 112 may provide a connection for user input through a keyboard, a mouse, and/or some other suitable input device. Further, input/output unit 112 may send output to a printer. Display 114 provides a mechanism to display information to a user.

Instructions for the operating system, applications, and/or programs may be located in storage devices 116, which are in communication with processor unit 104 through communications fabric 102. In these illustrative examples, the instructions are in a functional form on persistent storage 108. These instructions may be loaded into memory 106 for execution by processor unit 104. The processes of the different embodiments may be performed by processor unit 104 using computer implemented instructions, which may be located in a memory, such as memory 106.

These instructions are referred to as program code, computer usable program code, or computer readable program code that may be read and executed by a processor in processor unit 104. The program code, in the different embodiments, may be embodied on different physical or computer readable storage media, such as memory 106 or persistent storage 108.

Program code 118 is located in a functional form on computer readable media 120 that is selectively removable and may be loaded onto or transferred to data processing system 100 for execution by processor unit 104. Program code 118 and computer readable media 120 form computer program product 122. In one example, computer readable media 120 may be computer readable storage media 124 or computer readable signal media 126. Computer readable storage media 124 may include, for example, an optical or magnetic disc that is inserted or placed into a drive or other device that is part of persistent storage 108 for transfer onto a storage device, such as a hard drive, that is part of persistent storage 108. Computer readable storage media 124 also may take the form of a persistent storage, such as a hard drive, a thumb drive, or a flash memory that is connected to data processing system 100. In some instances, computer readable storage media 124 may not be removable from data processing system 100.

Alternatively, program code 118 may be transferred to data processing system 100 using computer readable signal media 126. Computer readable signal media 126 may be, for example, a propagated data signal containing program code 118. For example, computer readable signal media 126 may be an electro-magnetic signal, an optical signal, and/or any other suitable type of signal. These signals may be transmitted over communications links, such as wireless communications links, an optical fiber cable, a coaxial cable, a wire, and/or any other suitable type of communications link. In other words, the communications link and/or the connection may be physical or wireless in the illustrative examples.

In some illustrative embodiments, program code 118 may be downloaded over a network to persistent storage 108 from another device or data processing system through computer readable signal media 126 for use within data processing system 100. For instance, program code stored in a computer readable storage media in a server data processing system may be downloaded over a network from the server to data processing system 100. The data processing system providing program code 118 may be a server computer, a client computer, or some other device capable of storing and transmitting program code 118.

The different components illustrated for data processing system 100 are not meant to provide architectural limitations to the manner in which different embodiments may be implemented. The different illustrative embodiments may be implemented in a data processing system including components in addition to or in place of those illustrated for data processing system 100. Other components shown in FIG. 1 can be varied from the illustrative examples shown. The different embodiments may be implemented using any hardware device or system capable of executing program code. As one example, data processing system 100 may include organic components integrated with inorganic components and/or may be comprised entirely of organic components excluding a human being. For example, a storage device may be comprised of an organic semiconductor.

As another example, a storage device in data processing system 100 is any hardware apparatus that may store data. Memory 106, persistent storage 108, and computer readable media 120 are examples of storage devices in a tangible form.

In another example, a bus system may be used to implement communications fabric 102 and may be comprised of one or more buses, such as a system bus or an input/output bus. Of course, the bus system may be implemented using any suitable type of architecture that provides for a transfer of data between different components or devices attached to the bus system. Additionally, a communications unit may include one or more devices used to transmit and receive data, such as a modem or a network adapter. Further, a memory may be, for example, memory 106 or a cache such as found in an interface and memory controller hub that may be present in communications fabric 102.

As previously mentioned, RFP bid submission processes require that a client provide a detailed listing to the vendor that lists the client's existing inventory of IT assets. One problem with current client inventory submissions is that every client's inventory data is organized differently. Even when an experienced IT industry consultant firm is enlisted to assist a client in performing and managing the service bid process, there is still substantial uniqueness among each client's inventory data. For example, inventory data received from each client may be organized in different columns within a spreadsheet program. In addition, the amount of inventory data submitted by one client may differ from the amount of data submitted by another client. Prior to analyzing the inventory data to determine vendor service offerings that best fit a particular client, vendor personnel are often required to reorganize the client inventory data in order to get the data into a standard format that is easily readable and usable by the vendor. For instance, vendor personnel may organize the client inventory data by copying columns of the inventory data into a standard format worksheet that comprises columns in a standard order. Vendor personnel may also be required to standardize the text in the columns, as well as expand the inventory data by populating the worksheet with additional data about the inventory assets.

Currently, vendor personnel are required to manually perform the reorganizing, standardizing, and expanding of client-submitted inventory data. Due to the large number of items within the inventory data, these manual processes can result in many hours of vendor personnel time being expended toward processing the client's inventory data in order to return a bid for services to the client. The illustrative embodiments provide a solution to these problems by providing an inventory utility that allows for automating the processes of (1) organizing client-provided inventory data into a standard format and (2) analyzing the organized data to enable a user to quickly understand the scope of the client's inventory. By automating the processes of client inventory data organization and analysis, large amounts of inventory data can be quickly realigned and processed to enable vendor personnel to create a greater understanding of the client's IT inventory as it pertains to IT RFP bid submission, and to save time and assist in the development of successful service solutions.

As vendors often receive client inventory data submissions that are in a worksheet format, the inventory utility may be implemented using a spreadsheet program such as, for example, Microsoft Excel®. Microsoft Excel contains a macro programming language, Visual Basic for Applications (VBA), which provides an integrated development environment for automating user tasks. The inventory utility may be provided to a user as a prepackaged set of tools, which may include a set of pre-built reusable intellectual capital (IC). The inventory utility may include proprietary data and information, licensed 3^{rd} party data, publicly available data, or a combination of any of the above. The inventory utility may leverage the macro and logic features of the spreadsheet program to define and automate the organizing and analyzing of client-provided inventory data. The spreadsheet program may be modified to provide an enhanced user interface comprising toolbars and selectable buttons for initiating and executing the features of the inventory utility. The toolbars and selectable buttons may be incorporated into the spreadsheet program's macro code.

Vendor personnel may initiate the automated organization and analyzing of client inventory data by selecting a particular button in the user interface to trigger an initial client inventory data load process. In this load process, the vendor is first required to specify how the data in the client inventory data worksheet should be organized into a predetermined standard format. To do this, the vendor or user sets up and defines mappings between columns in the client inventory data worksheet and columns in a standard format worksheet. Setting up a mapping of worksheet columns comprises a manual process of specifying that a particular column of data in the client inventory data worksheet is to be copied from and pasted to a particular column in the standard format worksheet. The set up may include some minimal cursory review and adjustments as needed of the client's data toward ensuring that the client inventory data worksheet contains asset data only and does not contain any extra content, such as a pivot table containing formulas and other calculation content. The inventory utility processes all rows within the client inventory data worksheet and assumes that, with the exception of column headers, all the data in the worksheet is asset data only. The user should remove all non-asset specific content prior to initiating the load processing. Once all of the desired mappings for organizing the client inventory data are set and any non-asset specific content removed, the inventory utility processes the client inventory data such that the inventory utility automatically performs the reorganization of all of the mapped columns to the standard format worksheet. The reorganization feature of the inventory utility aligns the data for subsequent automated data analyzing processes and prepares the data for solution development using reusable processes and intellectual capital. The reorganization feature can process hundreds of line items in a worksheet in a fraction of the time it currently takes a user to process the data manually using current methodologies.

After the client inventory data has been reorganized into a standard format, the initial client inventory data load process performs an analysis of the organized inventory data. Analyzing client inventory data comprises an automated process of standardizing and/or expanding the organized client inventory data using macros or subroutines in the spreadsheet program. A macro is a set of commands and actions that operate on one or more columns of data and that can be stored and run whenever a task needs to be performed. Standardizing inventory data removes variations in how text within the worksheet is expressed and “cleans up” the text to comply with a standard or norm. Expanding inventory data derives additional data about client inventory assets based on the data within the worksheet and populates the standard format worksheet with the additional data. Both the standardizing and expanding processes use internal tables comprising additional data which may be relative to a particular asset within the client-provided inventory data. The standardizing and expanding macros or subroutines may use string searches of the data in the internal reference tables to identify whether text in the worksheet should be replaced with standardized text and whether new text may be added to the worksheet to further define the client's inventory information.

The initial client inventory data load process comprises a series of independent macros and subroutines executed in a defined sequence, followed by copying or posting of the standardized and expanded inventory data into an output workbook where intellectual capital reports are available for viewing the updated asset data in a variety of presentation formats. The sequence is defined within a bucket sort and scatter tally subroutine. The bucket sort portion of the subroutine calls each of the sequenced independent macros or subroutines to perform an analysis of the inventory asset data, One of the values returned as a result of the analysis is the designation of each inventory item as an asset type of Mainframe, Midrange, Server, Storage, Network, Workstation or Other. The scatter tally portion of the subroutine tallies the assets by asset type upon completion of the independent macros or subroutines sequence. When the bucket sort and scatter tally subroutine finishes its analysis of the inventory asset data, the tally totals for the assets types processed are displayed to the user. The purpose of the bucket sort process is to provide a location within the embodiments' program code logic to allow for segregation and storing of the asset data into separate respective asset type standard format worksheets. A preferred embodiment of the invention provides for storing all analyzed asset data in a single standard format worksheet, but with the inclusion of a bucket sort process contained within the program code logic, other embodiments may be configured to provide separate respective asset type standard format worksheets for one or more of the asset types.

The process of coping or posting the standardized and expanded inventory data into the output workbook includes a reusable intellectual capital (IC) pivot tables refresh subroutine which updates all identified output workbook reusable pivot tables with current cell range parameters. A pivot table report is an interactive table that automatically extracts, organizes, and summarizes your data. A user may use a pivot table to analyze the data, make comparisons, detect patterns and relationships, and discover trends. This cell range parameters update is an important process because scores of reusable pivot tables reside in the output workbook and all require accurate cell range settings. For instance, when existing information in the source data of the pivot table is changed, these data changes may simply be handled by refreshing the pivot table. However, if additional records have been added to the end of the source data or records are removed from the source data, the cell range used to create the pivot table must be redefined to reflect the additional/deleted cells. Without an automated means of updating quantities of pivot tables with accurate cell range settings, the user would be required to manually reset each pivot table with new cell range settings every time a row of inventory asset data was added or removed from the standard format worksheet. The pivot table refresh subroutine accomplishes the task of updating the range settings in all identified pivot tables through use of an internal reference table. This particular internal reference table provides a source of information related to all packaged reusable pivot tables, specifically a reference to the workbook in which the pivot table resides, the worksheet name in which a particular pivot table resides, the pivot table name, and the location of the pivot table within the referenced worksheet. This internal reference table is dynamic in that additional reusable pivot table references can be added to the table at anytime by the owner or administrator of the inventory utility or by a user trained in the operation. Additionally, as a means to reduce disk capacity and memory requirements, all identified reusable pivot tables reference a single master pivot table which functions as central pivot table to be referenced by all identified reusable pivot tables.

Optionally, the user may select a button in the user interface that performs the copying or posting of the processed inventory data into the output workbook. This button and processing capability included in the embodiments are provided as a means for the user to update the output workbook with any updates that may have been performed on the analyzed data since the last time the copy or posting was performed. The reusable IC reports are included in the embodiments' package for the purposes of providing a standardized look and feel to the output workbook and also to facilitate a number of commonly executed solution processes. Each report in the output workbook provides a unique view of the client's inventory content. The reusable reporting function of the inventory utility enables the user to quickly view and understand the scope of the client's IT assets toward developing a successful service solution to submit to the client.

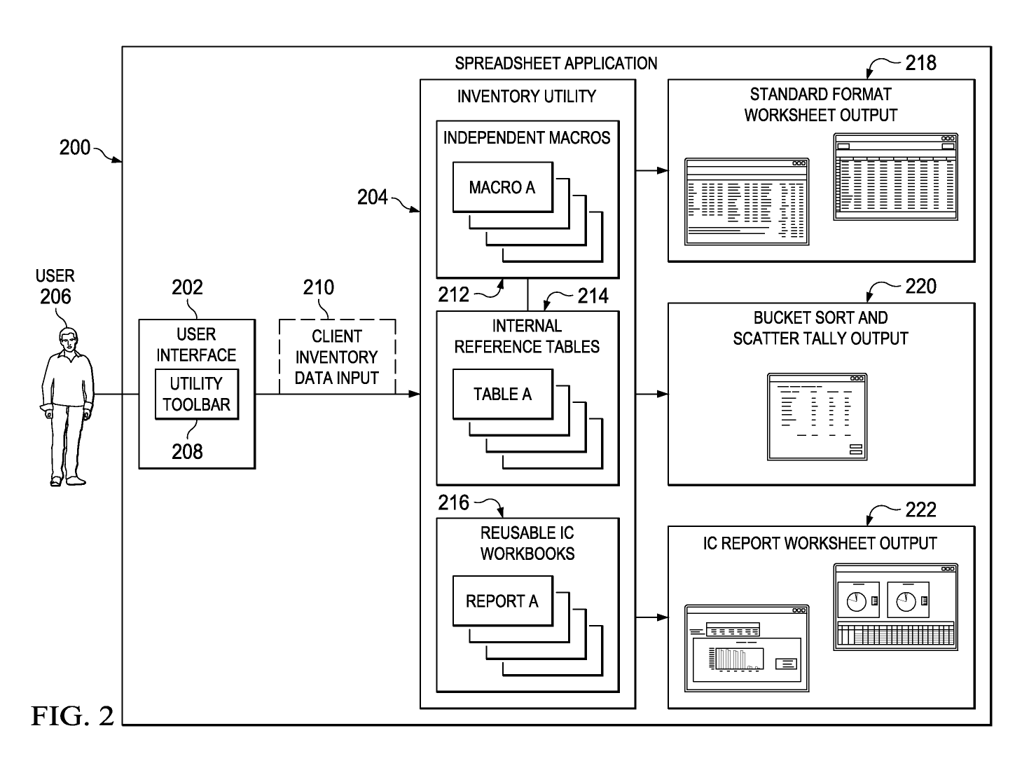

FIG. 2 is a block diagram of a spreadsheet application for organizing and analyzing client inventory data in accordance with the illustrative embodiments. Spreadsheet application 200 may be run on a data processing system, such as data processing system 100 in FIG. 1. Spreadsheet application 200 may be implemented as program code stored within memory 106 or on computer readable media 120 and executed by processor unit 104 in FIG. 1.

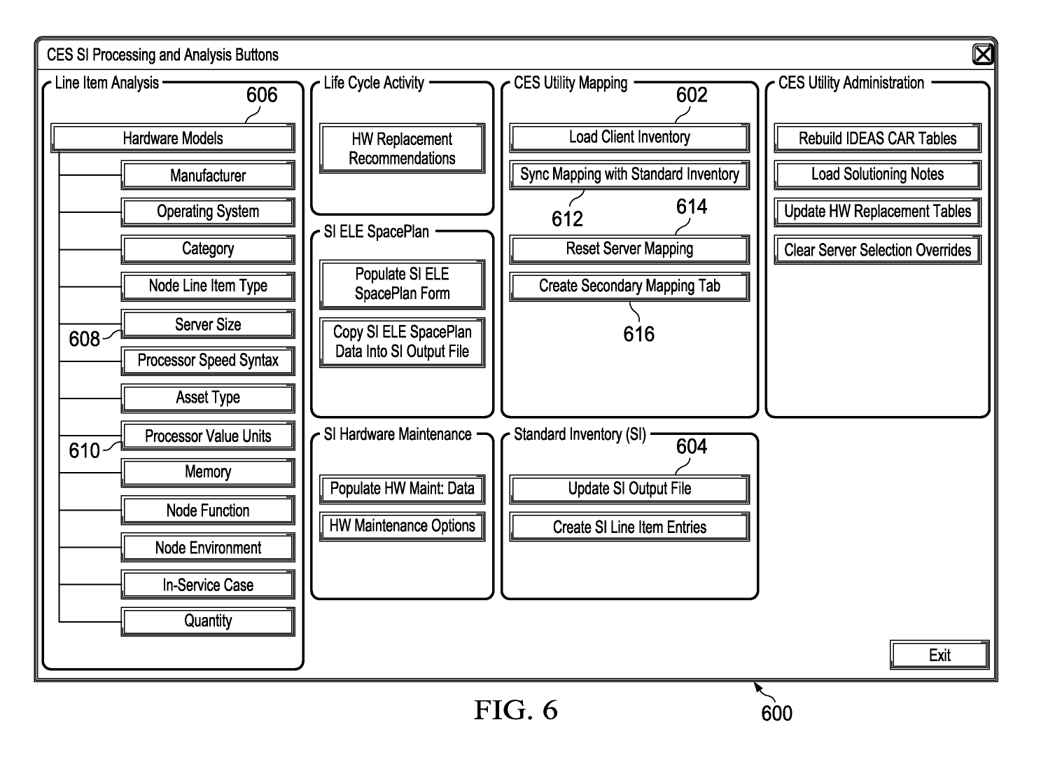

Spreadsheet application 200 is an enhanced program that includes a user interface, macros, tables, and reporting worksheets that spreadsheet application 200 uses to automatically organize and analyze client inventory data for use in a bid submission process. In this illustrative embodiment, spreadsheet application 200 comprises enhanced user interface 202 and inventory utility 204 with separate reusable IC report output workbook 216. User interface 202 provides data processing and report viewing options to a user 206. Specifically, user interface 202 comprises an inventory utility toolbar 208 of selectable buttons that enable user 206 to trigger one or more automated processes that operate on the client inventory data. These automated processes may include loading selected client inventory data into the spreadsheet application, reorganizing the inventory data into a standard format worksheet, standardizing and/or expanding the text in the data, and generating reports for displaying the inventory data in various forms. An example of the inventory utility toolbar in user interface 202 is shown in FIG. 6. When loading client inventory data 210 into the spreadsheet application, user interface 202 also allows user 206 to manually set mappings between columns in the client inventory data worksheet and columns in a standard format worksheet. User 206 sets up the mappings by specifying that a particular column of data in the client inventory data worksheet is to be copied from and pasted to a particular column in the standard format worksheet. In one embodiment, user 206 may map only those inventory columns that are deemed relevant to the user, and all other columns can be ignored.

Inventory utility 204 comprises a set of functions that perform the processes of organizing and analyzing of the client inventory data. Inventory utility 204 comprises a plurality of independent macros 212, internal reference tables 214, and reusable IC reports contained in a separate reusable IC reports output workbook 216. Independent macros 212 comprise commands and actions that operate on one or more columns of the inventory data. The general structure of an independent macro 212 comprises a shared variables definitions Call statement, a Do Loop which executes a line item macro that processes data for each row contained in the standard format worksheet, and other subroutines which are executed by the line item macro for each row of inventory data. The roles served by independent macros 212 are to enable a user to process line item data and to act as designated control points for shared subroutine code and cell update restrictions. Independent macros 212 follow several rules. First, the macro reads and processes all cells in the column(s) that is assigned to the particular independent macro (i.e., first content row through last content row). Second, the macro is allowed to read any or all column cells of the line item being processed for purposes of analysis or reference. Third, the macro is allowed to update only the cells within the column(s) that are assigned to the particular independent macro. Fourth, the macro will be the single source for shared subroutines which are unique to the function of that particular independent macro, including the high level line item subroutine each independent macro contains. For example, if a first independent macro contains IBM® Global Services Framework Blue (FWB) model hardware size category analysis related subroutine code and a second independent macro has a need to perform the same subroutine code, then the first macro will be the single source and owner of the subroutine being shared.

Within independent macros 212, reorganization, standardization, and expansion macros are provided to generate standard format worksheet output 218. Standard format worksheet output 218 is a worksheet file that comprises the client inventory data, organized and updated with standardized terms and additional information about the inventory, through which a user may use to save time and assist in the development of a client service solution. In creating standard format worksheet output 218, reorganization macros are first used to organize the client inventory data into a predetermined standard format. The reorganization macro uses the mappings between columns previously set by user 206 in the mapping format worksheet and automatically performs the reorganization of all of the mapped columns to the standard format worksheet. Consider for example, client inventory data 210 in which column A of the inventory data is mapped to column A in the standard format worksheet, column B of the inventory data is mapped to column D in the standard format worksheet, and column G of the inventory data is mapped to column T of the standard format worksheet. It should be noted that the example describes a very small subset of a typical client provided inventory which typically contains scores of columns. The reorganization macro automates the process of reorganizing the data by copying an entire column's data (e.g., column B of the inventory data) as a block of data and pasting it into a column in the standard format worksheet (e.g., column D of the standard format worksheet). A simple example of internal logic of the reorganization macro may be as follows:

Column A==>COPIED TO==>Column A of the standard format worksheet

Column B==>COPIED TO==>Column D of the standard format worksheet

Column G==>COPIED TO==>Column T of the standard format worksheet

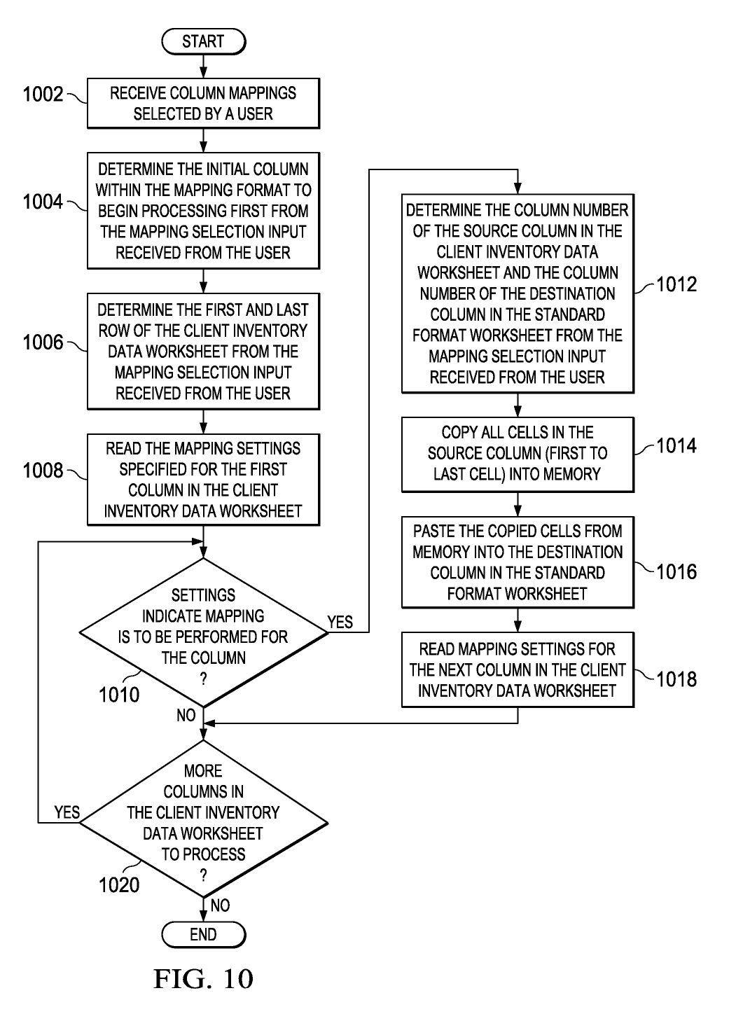

The reorganizing process is performed one column at a time (i.e., column A thru column GZ), until the entire mapped client inventory data columns are copied into their desired location within the standard format worksheet. The process flow is shown in FIG. 10. Column GZ is determined to be an acceptable stopping point within the logic of the reorganization macro because it allows for both the standard format worksheet column needs and the ability to allow a number of additional non-standard format columns to be appended following the standard format columns in the standard format worksheet and limiting unnecessary processing to a finite range of columns. Adding or deleting standard format worksheet columns requires that adjustments be made to the internal logic of the reorganization macro and shared variables definitions.

Standardization macros provided within independent macros 212 remove variations in how text is expressed in the worksheet by conforming the text to a standard form. For example, cell entries in the inventory data that read “Dell, Inc.” may be standardized to “Dell”, entries that read “Hewlett Packard” may be standardized to “HP”, etc. This example is also representative of standardization based on dynamic internal reference tables being used as a means to apply standards. Standards can be added, deleted or altered within the internal reference tables at anytime by the owner or administrator of the inventory utility or by a user trained in the operation.

Expansion macros provided within independent macros 212 derive additional data about the client inventory assets based on the asset data within the worksheet. As clients may provide a limited amount of asset information in the inventory data, the expansion macros automatically populate additional data into cells in the standard format worksheet that allows a user to further understand the scope of the client's IT assets. For this reason, expansion macros are very beneficial in that they populate the standard format worksheet with additional data related to the asset where data might otherwise have remained absent. Expansion macros also rely on internal reference tables for a means to gather additional data relative to a particular asset.

Independent macros 212 may be individually selected by user 206 via inventory utility toolbar 208 in user interface 202 to perform a specific task in a vertical manner (i.e., updating a single column of data to process any modifications made by the user to the inventory data in the standard format worksheet) or run as a group of macros in the initial client inventory data load process to organize and analyze the inventory data in a horizontal manner (i.e., updating multiple columns of data). The initial client inventory data load process executes a group of macros to provide an automated sequential process of importing the client inventory data, placing and reorganizing the data into a standard format worksheet, and analyzing the data using the independent macro subroutines. The initial client inventory data load process also uses a bucket sort and scatter tally subroutine in which the bucket sort portion of the subroutine calls each of the sequenced independent macros or subroutines to perform analysis of the inventory item asset data. One of the values returned as a result of the analysis is the designation of inventory item as an asset type of Mainframe, Midrange, Server, Storage, Network, Workstation or Other. The scatter tally portion of the subroutine tallies the assets upon completion of the independent macros or subroutines sequence. The bucket sort and scatter tally results 220 are provided to the user to enable the user to determine whether to segregate the inventory data of each asset type into its own standard format worksheet to enable the user to more easily read and understand the data.

Internal reference tables 214 are tables contained within inventory utility 204 that are referenced by both the macros in the initial client inventory data load process and the independent macros that are called individually to process user modifications to the data in the standard format worksheet. Examples of internal reference tables 214 may include, but are not limited to, string text filter tables, string text replacement tables, server performance ratings tables, hardware replacement recommendation tables, Microsoft Excel pivot reports reference table, IBM GTS Framework Blue costing and delivery model server hardware size ranges table, as well as other miscellaneous tables. In one embodiment, the internal reference tables 214 are used by the macros to update data within cells in the standard format worksheet by performing a string search to locate a match between the value in a current column cell of a line item in the worksheet and a value in an internal reference table corresponding to the column being analyzed. If a match is found, the value in the internal reference table is populated in the current column cell for standardization macros, and the value in the internal reference table is populated in another column cell for that line item in the worksheet for expansion macros. The data in internal reference tables 214 may be obtained from various historical, third party, and manually populated sources. The internal reference tables may be dynamic in that additional references within a particular internal reference table can be added to the table at anytime by the owner or administrator of the inventory utility or by a user trained in the operation.

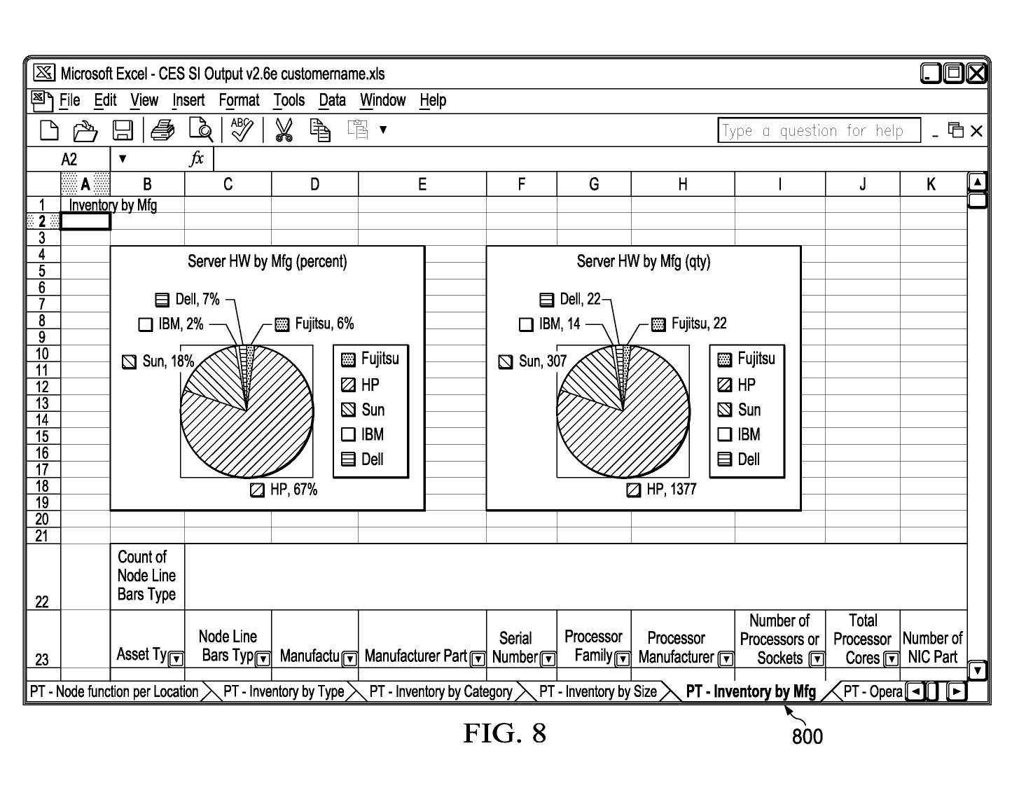

Reusable IC Reports 216 are pre-built worksheets contained within inventory utility 204 that are used to generate IC report worksheet output 222. Each reusable IC report is designed to provide a unique and specific view of the inventory data. After inventory data has been organized and analyzed by inventory utility 204, the user may select one or more reusable IC reports from user interface 202 in which to display the inventory data. Reusable IC reports 216 obtain the inventory data contained within the standard format worksheet and display the inventory data according to the structure of the particular report format. An example of a reusable IC report is shown in FIG. 8.

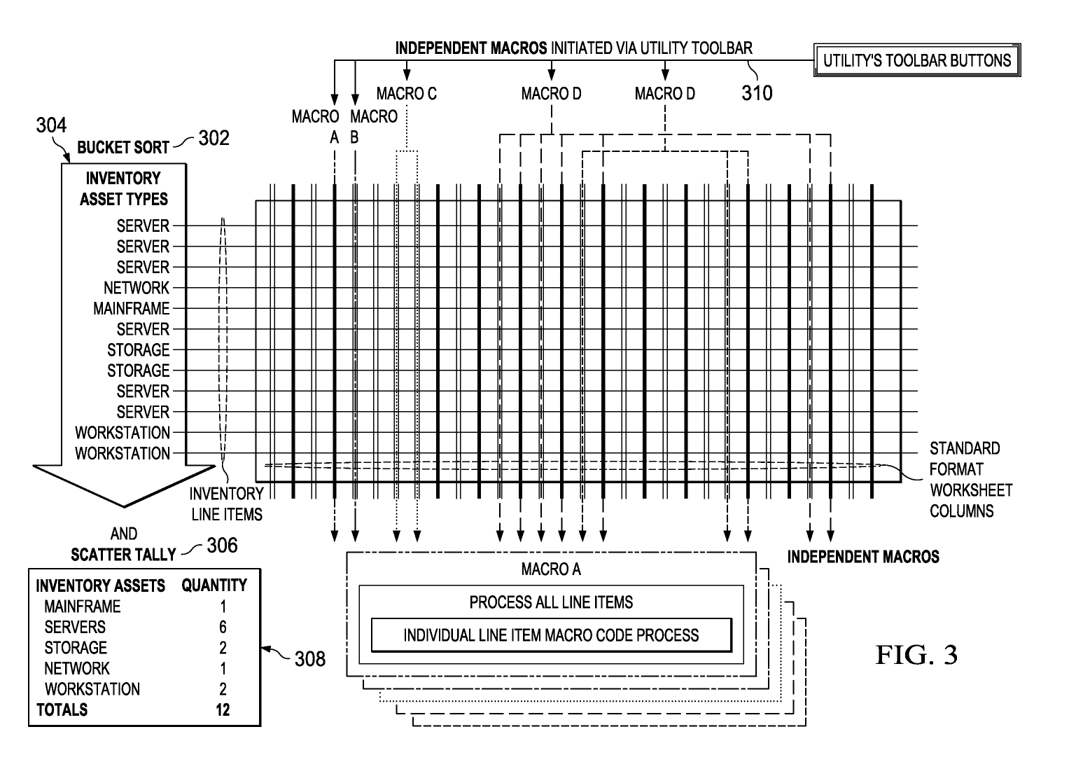

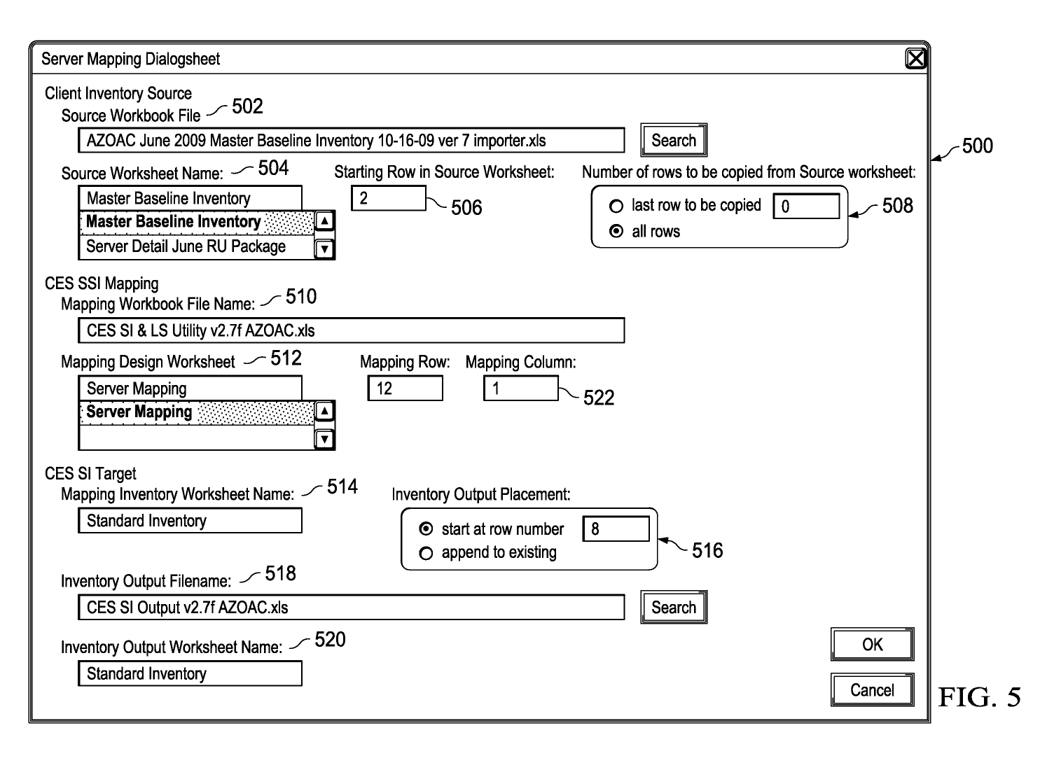

FIG. 3 is an integrated view of components comprising the initial client inventory data load and independent macros in accordance with the illustrative embodiments. The initial client inventory data load first receives input from the user in which the user sets up an initial mapping structure that is used by the reorganization macro in the initial client inventory data load process to reorganize the client inventory data into a standard format worksheet. Next, the user may be prompted via a pop-up window to identify the client inventory source workbook and worksheet which contains the client inventory data. An example of this pop-up window is shown in FIG. 5. When the user selects the client inventory data source, the initial client inventory data load process initiates an automated bucket sort process 302 which executes a series of independent macro line item subroutines (standardization and expansion macros) that standardize and expand the client inventory data in the standard format worksheet and sorts the assets in the data into asset types 304. Once the bucket sort processing completes, the initial client inventory data load performs a scatter tally process 306 which calculates the number of assets within each identified asset type. The initial client inventory data load displays the results of the scatter tally process 306 in the form of a scatter tally pop-up window 308.

Independent macros 310 may also be initiated by a user by selecting an independent macro button in the inventory utility toolbar. Each independent macro is used to process one or more columns of data in the standard format worksheet. Independent macros 310 may be selected by the user as a means to process any modifications that were made by the user to the client inventory data in the standard format worksheet.

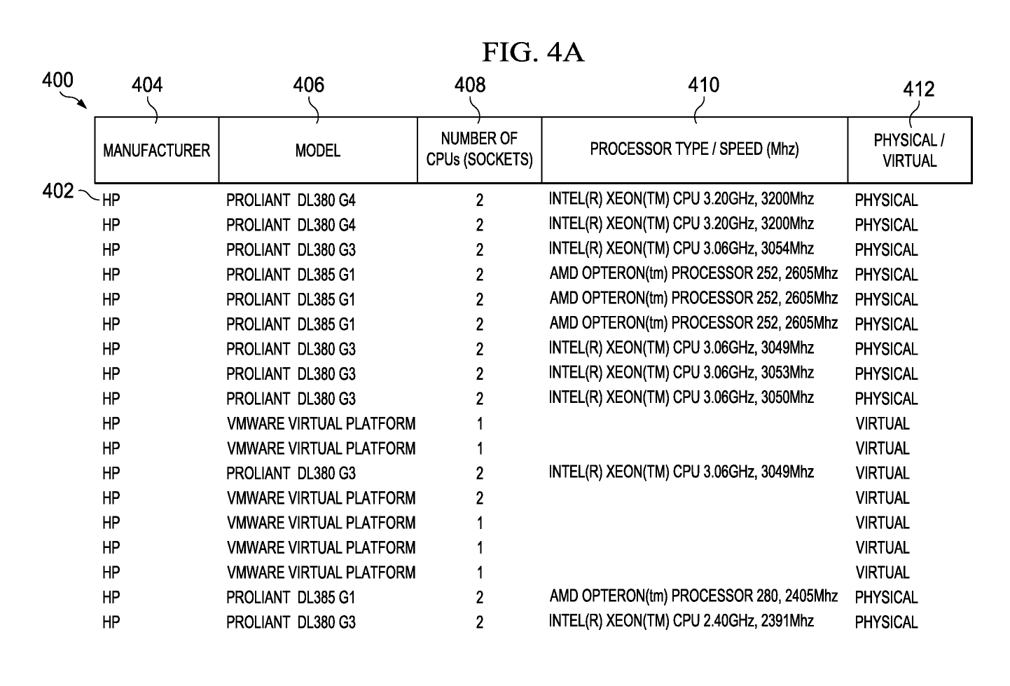

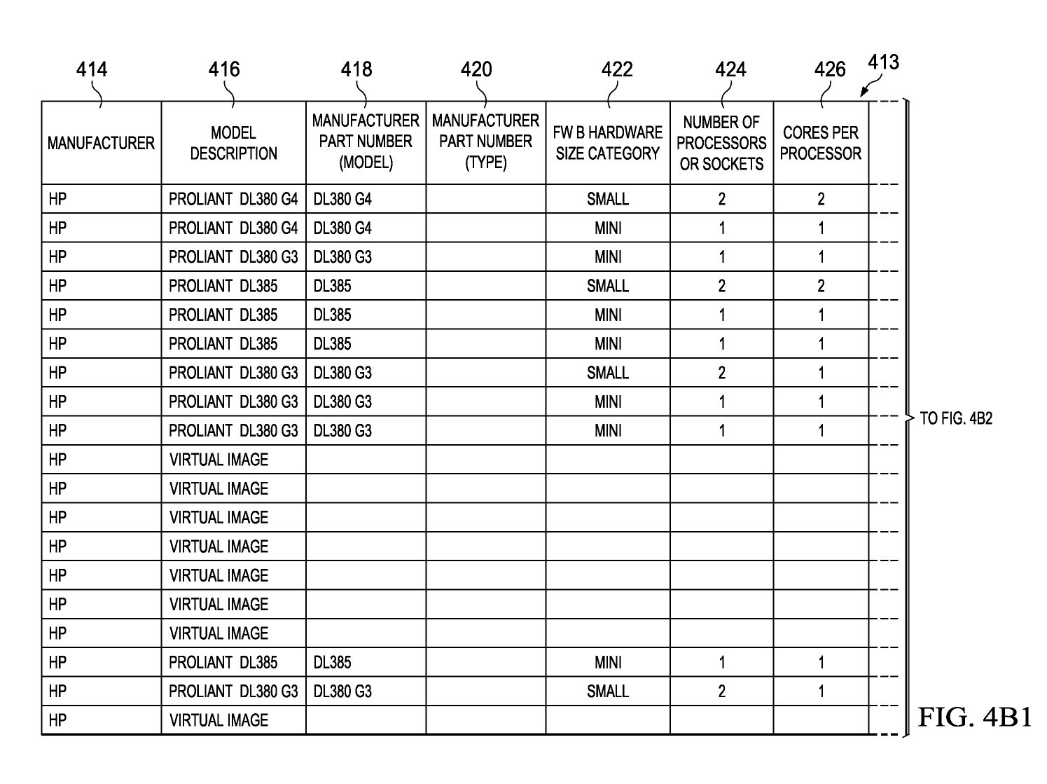

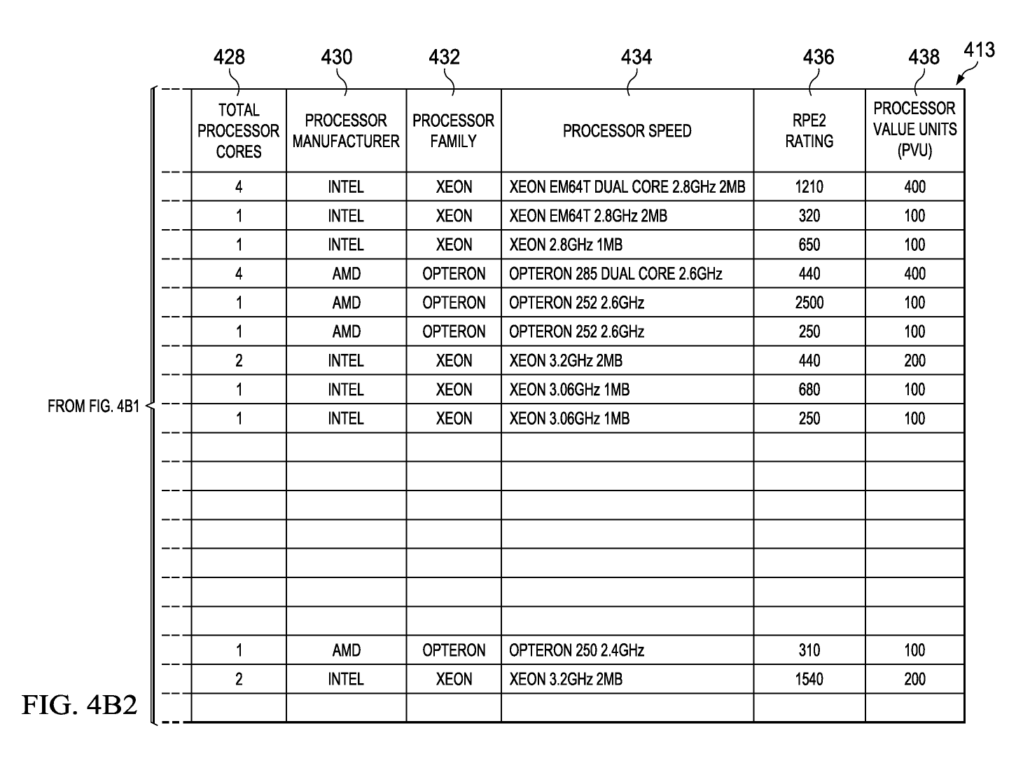

FIGS. 4A and 4B illustrate an example of client inventory data as initially received by a vendor and after the data is organized and analyzed by the inventory utility in accordance with the illustrative embodiments. Inventory data 400 in FIG. 4A comprises a detailed listing of IT assets in an initial worksheet format as prepared by the client. Each line item 402 in the initial inventory worksheet contains a particular IT asset of the client, and each column 404-412 indicates a particular attribute of an asset. It should be noted that the inventory data provided in this illustrative example may be a small subset of a typical client's provided inventory which often contains scores of line items and columns.

FIGS. 4B1 and 4B2 illustrate an exemplary standard format worksheet 413 comprising the output of the initial client inventory data load process that is applied to inventory data 400 in FIG. 4A. In this illustrative example, the initial client inventory data load process organizes the client inventory data into a standard data format by copying columns of data in the client inventory data into their respective columns in the standard format worksheet. The user may load a portion of the client inventory data by specifying a starting row 506 and a last row 508 in FIG. 5. All of the data or a portion of the data may be copied from cells in the source column to a single destination column or to multiple destination columns. For example, data in manufacture 404 in inventory data 400 is copied to manufacture 414 in standard format worksheet 413, data in hardware model 406 is copied to hardware model description 416 and manufacture part number 418, and data in processor type/speed 410 is copied to processor manufacturer 430, processor family 432, and processor speed 434.

The initial client inventory data load process also standardizes the text in these columns to provide uniformity to the same data values and populates additional information into other columns in the standard format worksheet, as shown in columns 422 and 426-438. For instance, the initial client inventory data load process in this example may include a series of three macros for analyzing the inventory data. A first macro (macro A) is run against each line item which analyzes the hardware model 406 and the number of processors or sockets counts 408 and uses the internal reference tables to obtain additional information associated with the model and processor/socket counts. This additional information may comprise data about the total processor cores quantity 428, the cores per processor count 426, the processor speed 434, as well as other chip related details. Once this additional information is obtained, macro A may use the additional information to further determine, using the internal reference tables, the RPE2 rating (performance rating) 436 of the inventory items, while also standardizing the text by referencing various internal string filtering and replacement reference tables.

A second macro (macro B) analyzes the RPE2 rating results 436 determined from macro A and uses the rating results to determine the FWB hardware size category 422 for each line item. A third macro (macro C) analyzes the total processor cores quantity 428 determined from macro A and the processor family data 432 and uses the internal reference tables to determine the IBM software license related processor value units (PVU) 438 for each line item. It should be noted that the values in FIGS. 4A and 4B are merely representative and not meant to be actual values.

In one embodiment, the display of the data in standard format worksheet 413 comprising the output of the initial client inventory data load process and any subsequent data updates reflects any changes made to the syntax of the initial client inventory data or any additional expanded data. These syntax or additional expanded data may be displayed in a format distinguishable (e.g., such as displayed in a different color or font) from data in standard format worksheet 413 that remains in the format provided by the client.

FIG. 5 is an exemplary pop up window through which the user may input specifics related to workbooks and worksheets and set the column mapping structure between selected client provided inventory data and a standard format worksheet in accordance with the illustrative embodiments. Window 500 may be presented to the user when the user initiates the initial client inventory data load process, such as by selecting button 602 in FIG. 6. Within window 500, a client inventory source section is provided in which the user may specify which client inventory data to load into the spreadsheet application by identifying a source workbook file 502 and selecting the desired client inventory data file (source worksheet name 504) within the workbook. If client data is received in multiple worksheets, the user input process may be repeated and data appended to other data already processed. The user may specify the starting row 506 and the last row 508 in the client inventory data file that are to be loaded into the spreadsheet application.

A client engagement system mapping section is also provided in window 500 in which the user may specify the name of the mapping workbook file 510 and select the particular mapping design structure 512 to be used for the reorganization process. The user may specify the name of the target standard format worksheet 514 in which the client inventory data is to be loaded for reorganizing and analysis and the starting row of the output 516. Window 500 also allows the user to specify the name of the output workbook 518 and standard format worksheet 520 within the output workbook into which the reorganized and analyzed inventory data will be copied.

FIG. 6 is an exemplary user interface through which inventory data processing and analyzing functions may be initiated in accordance with the illustrative embodiments. User interface 600 comprises a plurality of selectable buttons that trigger a variety of automated processes, such as the initial client inventory data load, independent macros, and specific inventory reports. For example, selection of load client inventory button 602 by the user may trigger the initial client inventory data load process. Update standard inventory (SI) output file 604 may be selected to generate a reusable IC report that provides a specific view of the client inventory data. Independent macros within user interface 600 may be selected by the user to individually run specific macros on the inventory data. Consider the initial client inventory data load process example comprising macros A, B, and C that was previously described in FIGS. 4A and 4B. The user may select and run any of these macros individually or as a series of macros to update the data in the respective columns of each macro. For instance, independent macro A may be individually triggered to run a series of independent macros to standardize and expand the data of many columns within the standard format worksheet as shown in FIGS. 4A and 4B if the user selects the hardware models button 606. Selection of server size button 608 may trigger independent macro B, and selection of processor value units button 610 may trigger independent macro C.

Additionally, sync mapping with standard inventory button 612, reset server mapping button 614, and create secondary mapping tab button 616 are provided to further simplify user efforts in mapping client inventory data into a standard format. Sync mapping with standard inventory button 612 may be selected by the user to expand the standard format worksheet to contain additional client provided data. For example, in cases where the client provided data may contain columns that do not have corresponding columns in the standard format worksheet, the user may want to retain all of the client provided data by mapping and appending those client data columns that do not have corresponding columns in the standard format worksheet to the end of the standard format worksheet. In this situation, selection of sync mapping with standard inventory button 612 allows the inventory utility to synchronize the column header row content of the server mapping, the standard format workbook, and the reusable intellectual capital standard inventory workbook by copying the column header row content of the server mapping defined by the user with the column header row in the standard format workbook and the column header rows in the reusable intellectual capital standard inventory workbook to enable the inventory utility to manage and utilize pivot tables, pivot charts, and other custom tables. Reset server mapping button 614 may be selected by the user to remove the previous mappings set between the columns in the client inventory data worksheet and columns in the standard format worksheet in an automated manner and return the mapping settings to a default standard format template. Create secondary mapping tab button 616 may be selected by the user in cases where the client provided data is received in multiple worksheet formats and the column headers of the different worksheets are not in alignment. For example, the client provided data may comprise a list of all Unix® servers in one worksheet, a list of all storage units in another worksheet, etc. Unix is a registered trademark of The Open Group in the United States and other countries. As the column headers in the Unix server worksheet are different from the column headers in the storage units worksheet, selection of create secondary mapping tab button 616 allows the user to create separate mappings to the standard format worksheet for both of the Unix server worksheet and the storage unit worksheet.

Selectable buttons within user interface 600 may also include processes that specify proposed target platforms and determine hardware technology refresh replacement recommendations in response to receiving user changes and alterations to standard format worksheet data content. These processes may also include applying independent macro and subroutines to identify, analyze, compare, determine and populate recommended server hardware technology replacement based on a server performance rating, and also to identify, analyze and populate proposed physical to virtual candidates.

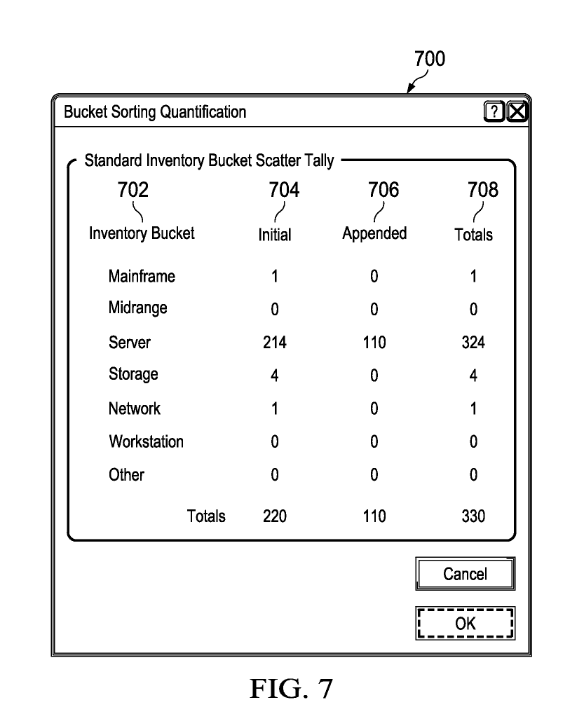

FIG. 7 is a pop up window illustrating exemplary bucket sort and scatter tally results displayed to the user in accordance with the illustrative embodiments. Window 700 may be presented to the user as a part of the bucket sort/scatter tally process in the initial client inventory data load or from the execution of an independent bucket sort/scatter tally macro when data is modified in or appended to the standard format worksheet. In the inventory bucket column 702, window 700 displays each asset type identified in the client inventory data. The asset type counts that were identified from the initial client inventory data load process are displayed in the initial column 704, and the asset type counts that were identified from appending new client data to the standard format worksheet is displayed in the appended column 706. The totals column 708 comprises the total number of each asset type in the standard format worksheet.

FIG. 8 is an exemplary reusable intellectual capital worksheet report in accordance with the illustrative embodiments. The inventory utility may comprise various pre-built reusable IC worksheets in which to display the processed client inventory data. Each pre-built reusable IC worksheet is designed to provide a unique and specific view of the inventory content. For example, report worksheet 800 displays information about server assets in the standard format worksheet. The report worksheets may display particular information in the standard format worksheet in various forms. In this example, report worksheet 800 displays the manufacturers of the server assets in pie chart form.

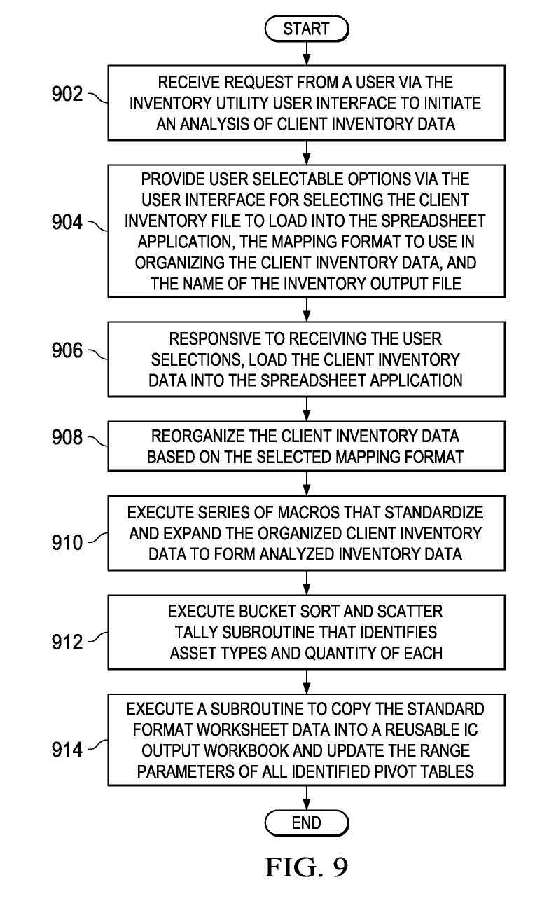

FIG. 9 is a flowchart of a process for organizing and analyzing client inventory data in an automated manner in accordance with the illustrative embodiments. The process described in FIG. 9 comprises an initial client inventory data load process that may be implemented within spreadsheet application 200 in FIG. 2.

The process begins with the inventory utility in the spreadsheet application receiving a request from a user to initiate an analysis of client inventory data (step 902). The user may create the request by selecting an initial client inventory data load button on the inventory utility user interface in the spreadsheet application. The inventory utility provides selectable options in the user interface for selecting the client inventory file to load into the spreadsheet application, the mapping format to use in organizing the client inventory data, and the name of the standard format worksheet output (step 904). Responsive to the receiving the user selections, the inventory utility loads the client inventory data into the spreadsheet application (step 906). The inventory utility reorganizes the client inventory data within the standard format worksheet based on the selected mapping format (step 908).

A series of macros is then executed which standardize and expand the organized client inventory data to form analyzed inventory data in the standard format worksheet (step 910). Once the data is analyzed, the inventory utility executes a bucket sort and scatter tally subroutine which categorizes or sorts the assets in the analyzed inventory data by type of asset and tallies the number of assets in each asset type (step 912). The inventory utility then executes a subroutine to copy the standard format worksheet data into a reusable IC output workbook and update the range parameters of all identified pivot tables (step 914). After the inventory data has been analyzed and copied into a reusable IC output workbook, the user may perform further analysis and modification of the client inventory data. The user may use the bucket sort and scatter tally results to determine whether or not to segregate the inventory data for the different asset types in different worksheets, as the asset types may comprise different attributes and utilize different columns in the worksheet. The process described in FIG. 9 may be followed by an iterative process of repetitively refining the standard format worksheet data through both manual updates and the use of user interface buttons to perform additional automated processing.

In a preferred embodiment, the process described in FIG. 9 may begin when the vendor receives an RFP including a digitized client inventory listing in a Microsoft Excel worksheet format. Following corporate internal engagement processes, the vendor provides the client's inventory data submission to the person who is assigned the responsibility of using the utility toward analyzing the data. The assigned user acquires the most current release of the packaged utility and places it in a file directory folder on his or her computer system's internal disk. If the package is in a compressed format, i.e. zipped folder, then the user will need to extract the package content into the directory folder. The user then performs a cursory review of the client inventory listing for the purpose of understanding how the client inventory is organized and what types of information have been submitted and included in the inventory data listing. The user validates that the client inventory data worksheet contains asset data only and does not contain any extra content, such as pivot table containing formulas and other calculation content. If the client inventory data worksheet contains any extra content beyond just asset data arranged in columns then the user is responsible for removing the extra content and ensuring that the client inventory data is organized in a format which is suitable for subsequent loading and processing by the utility. Then the user begins the manual mapping process of setting up the mapping of the client inventory data to the standard inventory format by specifying that a particular column of data in the client inventory data worksheet is to be copied from and pasted to a particular column in the standard format worksheet.

Once the user completes the mapping, then the user may sync the mapping column headers with the utility standard inventory column headers and the output standard inventory column headers. The user may perform the synchronization by clicking on or otherwise selecting the utility's toolbar standard inventory button which then displays a set of buttons shown in exemplary FIG. 6 and clicking on or otherwise selecting the ‘sync mapping with standard inventory’ button. A pop up window is displayed which provides a means to search through the user's local file directory and select the utility reusable IC output workbook to be synchronized, as shown in exemplary FIG. 5. The mapping format worksheet is contained in the utility along with the standard inventory format worksheet. Since the utility workbook is already open, there is no need to search for its name. If the user is satisfied that the correct output workbook has been selected then the user clicks on or otherwise selects the pop up window's OK button to perform the synchronization of the three worksheets column headers.

With the mapping process completed and the synchronization performed the user is now ready to proceed to the next step of loading and analyzing the client's inventory data. The user may now click on or otherwise select the utility's toolbar standard inventory button again which then displays a pop up dialog containing a set of buttons shown in FIG. 6. This time the user clicks on or otherwise selects the ‘load client inventory’ button. Another pop up window containing a set of settings along with workbook and worksheet input fields is displayed to the user. The user enters the appropriate setting, workbooks, and worksheets into the input fields and, if user is satisfied that the correct entries have been made, the user clicks on or otherwise selects the pop up window's OK button to begin the automated inventory data load and processing.

The inventory utility processes the client inventory data such that the inventory utility automatically performs the reorganization of all of the mapped columns to the standard format worksheet as determined by the user's previous mapping process activity, standardizes the text in multiple columns to provide uniformity to the same data values, and populates additional information into other columns in the standard format worksheet as determined by analysis findings. The utility may periodically display processing status information on the Excel status bar during processing period.

Once the inventory data load and analysis processes are complete, the utility displays the sort and scatter tally pop up window shown in FIG. 7, then the user clicks on or otherwise selects the pop up window's OK button to begin the process of coping the resulting standardized and expanded inventory data into the output workbook. A pop up window is displayed that indicates that the copy step has completed, and the user clicks on or otherwise selects the pop up message window's OK button to begin the process of updating all identified output workbook reusable pivot tables with current cell range parameters, and then returns control of the spreadsheet program back to the user. While the utility is performing the automated process, the user is unable to perform any tasks using the spreadsheet program with the exception of responding to pop up windows when they are displayed, but the user may be able to perform other activities unrelated to Excel and the utility which is executing to the extent that the user's computer has the performance capacity to perform other computer applications. After successful completion of the initial load process, the user may then begin reviewing the reusable IC output pivot tables, pivot charts, and other custom tables as well as the standard inventory format worksheet.

At this point, the user may enter into an iterative process of making adjustments to the contents of standard inventory format worksheet followed by selecting any of the various independent macro related buttons which are displayed when the utility's toolbar standard inventory button is clicked on or otherwise selected to perform additional automated updates to the client's inventory data and any user applied updates that may have been performed on the analyzed data. The user may also periodically click on or otherwise select the ‘update SI output file’ button in FIG. 6 to initiate the process of copying the resulting standardized and expanded inventory data into the output workbook and updating all identified output workbook reusable pivot tables with current cell range parameters. The user may use the many reusable pivot tables to analyze the data, make comparisons, detect patterns and relationships, and discover trends toward developing a successful service solution to submit to the client.

FIG. 10 is a flowchart illustrating mapping and inventory load macro code processing in accordance with the illustrative embodiments. The process in FIG. 10 provides additional detail of the process of mapping of client inventory data to a standard format worksheet as described in steps 906 and 908 in FIG. 9.

The process begins with the inventory utility receiving user selections that specify the client inventory file (e.g., source workbook file 502 in FIG. 5) to load into the spreadsheet application, the mapping format (e.g., mapping design worksheet 512 in FIG. 5) to use in organizing the client inventory data, and the name of the standard format worksheet output (e.g., mapping inventory worksheet name 514 in FIG. 5) (step 1002). The inventory utility then determines the initial column within the mapping format to begin processing first from the mapping selection input (e.g., mapping column 522 in FIG. 5, where “1” is the default value) received from the user (step 1004). The inventory utility also determines the first row 506 and last row 508 in FIG. 5 of the client inventory data worksheet from the mapping selection input received from the user (step 1006).

The inventory utility then begins reading the user specified mapping settings in the mapping format starting at the initial column of the mapping format (step 1008). The inventory utility makes a determination as to whether the mapping settings for the column indicate that the mapping is to be performed for the column (step 1010). If the column is not to be mapped, the process continues to step 1020.

However, if the column is to be mapped, the inventory utility determines the column number of the source column in the client inventory data worksheet and the column number of the destination column in the standard format worksheet from the mapping selection input received from the user (step 1012). The inventory utility copies all of the cells in the source column (first to last cell) into memory (step 1014). The inventory utility then pastes the copied cells from memory into the destination column in the standard format worksheet (step 1016). The mapping settings for the next column in the client inventory data worksheet is read by the inventory utility (step 1018).

The inventory utility then makes a determination as to whether any more columns in the client inventory data worksheet exist to process (step 1020). If so, the process loops back to step 1010 to determine if the current column indicates mapping is to be performed. However, if no more columns exist in the client inventory data worksheet, the process terminates thereafter.

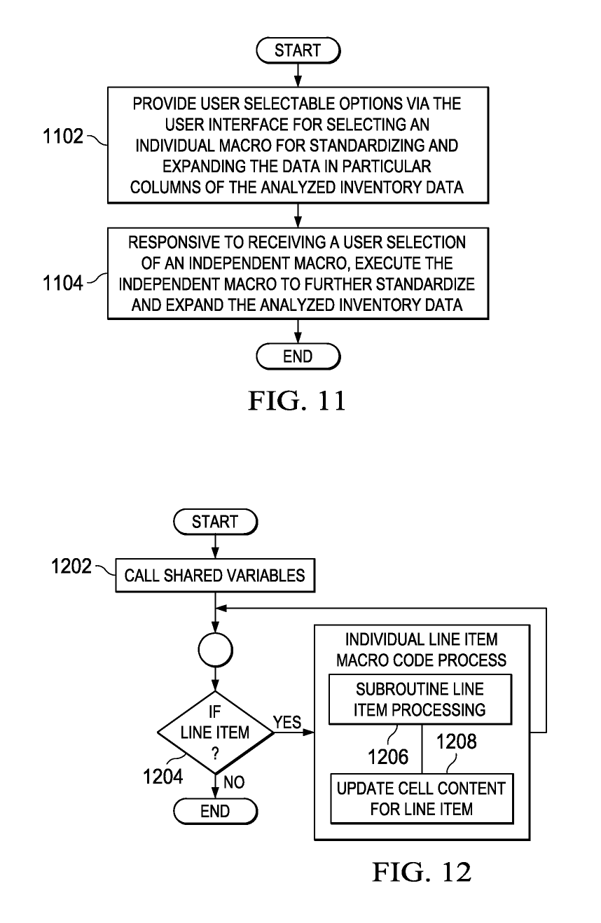

FIG. 11 is a flowchart of a process for further analyzing client inventory data in an automated manner using independent macros in accordance with the illustrative embodiments. The process described in FIG. 11 may be implemented within spreadsheet application 200 in FIG. 2 when the user has made manual modifications to the analyzed inventory data and wants updates to be made to the inventory data automatically based on the modifications and the selected macro.

The process begins with the inventory utility providing user selectable options via the user interface for selecting an independent macro for standardizing and/or expanding the data in particular columns of the analyzed inventory data (step 1102). Responsive to receiving a user selection of an independent macro, the inventory utility executes the independent macro to further standardizing and/or expanding the analyzed inventory data in an automated manner (step 1104).

FIG. 12 is a flowchart illustrating exemplary macro code processing in accordance with the illustrative embodiments. When an independent macro or subroutine is executed by the inventory utility, the independent macro first calls a set of shared variables (step 1202) and makes a determination as to whether a next line item in the worksheet exists for processing (step 1204). If a next line item does not exist, the process terminates thereafter. However, if a next line item does exist, the macro performs the subroutine processing on the line item (step 1206) and updates the cell content of the line item (step 1208). The process continues in a loop back to step 1204 to determine if another line item in the worksheet exists for the macro to process.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

The invention can take the form of an entirely hardware embodiment, an entirely software embodiment or an embodiment containing both hardware and software elements. In a preferred embodiment, the invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any tangible apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk—read only memory (CD-ROM), compact disk—read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method for managing inventory data, wherein the method is performed by a processing unit in a data processing system, the method comprising:
receiving, from a client, a first set of inventory data in a first worksheet format in a memory of the data processing system;
receiving user-defined mappings between columns in the first worksheet format and columns in a standard format worksheet;
responsive to receiving the user-defined mappings, organizing the first set of inventory data by copying each column of the first set of inventory data to its corresponding mapped column in the standard format worksheet to form organized inventory data;
applying a first set of independent subroutines to analyze the organized inventory data by standardizing text in the organized inventory data and populating one or more columns in the standard format worksheet with data derived from the first set of inventory data to form analyzed inventory data;
applying a second set of independent subroutines to the analyzed inventory data to sort inventory assets listed in the standard format worksheet by asset type and determine a total count of assets in each asset type to form sorted asset type data; and
displaying the sorted asset type data to a user.

2. The method of claim 1, further comprising:
responsive to displaying the sorted asset type data to the user, receiving user input to place the analyzed inventory data in separate asset standard format worksheets based on asset type.

3. The method of claim 1, further comprising:
responsive to receiving user changes to data in the standard format worksheet, applying an appropriate independent subroutine to the data to reanalyze the data in the standard format worksheet.

4. The method of claim 3, wherein the appropriate independent subroutine is provided to the user as a selectable button in a user interface and applied to the data upon selection of the appropriate independent subroutine by the user.

5. The method of claim 1, wherein the user-defined mappings are selected by the user from a list of server mapping worksheets.

6. The method of claim 1, wherein receiving the user-defined mappings further comprises receiving selection of the first set of inventory data to load into a spreadsheet program, a mapping format to use in organizing the first set of inventory data, and a name of the standard format worksheet.

7. The method of claim 1, further comprising:
applying a third set of subroutines to copy the analyzed inventory data into a reusable intellectual capital output workbook; and
responsive to receiving user selection of an output worksheet in the reusable intellectual capital output workbook, displaying the output worksheet comprising the analyzed inventory data to the user.

8. The method of claim 7, wherein the reusable intellectual capital output workbook comprises one or more pivot tables, pivot charts, and custom tables.

9. The method of claim 8, further comprising:
responsive to receiving user changes to data within the standard format worksheet, updating the reusable intellectual capital output workbook by refreshing the one or more pivot tables, pivot charts, and custom tables to reflect the user changes to the data.

10. The method of claim 8, further comprising:
responsive to receiving user changes to data within the standard format worksheet that add additional columns or rows of data from the standard format worksheet, updating the reusable intellectual capital output workbook by changing range parameters for the one or more pivot tables, pivot charts, and custom tables to incorporate the additional columns or rows of data.

11. The method of claim 1, further comprising:
responsive to receiving a second set of inventory data in a second worksheet format from the client, applying a third set of independent subroutines to create a secondary mapping format to use for mapping to the second set of inventory data.

12. The method of claim 1, further comprising:
applying a third set of independent subroutines to reset the user-defined mappings to a default set of mappings.

13. The method of claim 1, further comprising:
synchronizing a server mapping workbook comprising the user-defined mappings, a standard format workbook comprising the standard format worksheet, and a reusable intellectual capital output workbook comprising output worksheets by replacing column header row content in the standard format workbook and the reusable intellectual capital output workbook with column header row content of the server mapping workbook.

14. An apparatus comprising:
a bus;
a storage device connected to the bus, wherein the storage device contains computer usable code; and
a processing unit connected to the bus, wherein the processing unit executes the computer usable code to receive, from a client, a first set of inventory data in a first worksheet format in a memory of the data processing system; receive user-defined mappings between columns in the first worksheet format and columns in a standard format worksheet; responsive to receiving the user-defined mappings, organize the first set of inventory data by copying each column of the first set of inventory data to its corresponding mapped column in the standard format worksheet to form organized inventory data; apply a first set of independent subroutines to analyze the organized inventory data by standardizing text in the organized inventory data and populating one or more columns in the standard format worksheet with data derived from the first set of inventory data to form analyzed inventory data; apply a second set of independent subroutines to the analyzed inventory data to sort inventory assets listed in the standard format worksheet by asset type and determine a total count of assets in each asset type to form sorted asset type data; and display the sorted asset type data to a user.

15. A computer program product for managing inventory data, the computer program product comprising:
a computer readable storage medium having computer readable program code stored thereon, the computer readable program code for execution by a computer, comprising:
computer readable program code for receiving user-defined mappings between columns in the first worksheet format and columns in a standard format worksheet;
computer readable program code for organizing, in response to receiving the user-defined mappings, the first set of inventory data by copying each column of the first set of inventory data to its corresponding mapped column in the standard format worksheet to form organized inventory data;
computer readable program code for applying a first set of independent subroutines to analyze the organized inventory data by standardizing text in the organized inventory data and populating one or more columns in the standard format worksheet with data derived from the first set of inventory data to form analyzed inventory data;
computer readable program code for applying a second set of independent subroutines to the analyzed inventory data to sort inventory assets listed in the standard format worksheet by asset type and determine a total count of assets in each asset type to form sorted asset type data; and
computer readable program code for displaying the sorted asset type data to a user.

16. The computer program product of claim 15, further comprising:
computer readable program code for receiving, in response to displaying the sorted asset type data to the user, user input to place the analyzed inventory data in separate asset standard format worksheets based on asset type.

17. The computer program product of claim 15, further comprising:
computer readable program code for applying, in response to receiving user changes to data in the standard format worksheet, an appropriate independent subroutine to the data to reanalyze the data in the standard format worksheet.

18. The computer program product of claim 15, wherein receiving the user-defined mappings further comprises receiving selection of the first set of inventory data to load into a spreadsheet program, a mapping format to use in organizing the first set of inventory data, and a name of the standard format worksheet.

19. The computer program product of claim 15, further comprising:
computer readable program code for applying a third set of subroutines to copy the analyzed inventory data into a reusable intellectual capital output workbook; and
computer readable program code for displaying, in response to receiving user selection of an output worksheet in the reusable intellectual capital output workbook, the output worksheet comprising the analyzed inventory data to the user.

20. The computer program product of claim 15, wherein the reusable intellectual capital output workbook comprises one or more pivot tables, pivot charts, and custom tables.
